(19) United States
(12) Patent Application Publication
(10) Pub. No.: US 2006/0048785 A1
(43) Pub. Date: Mar. 9, 2006

(54) Human body supporting device

(76) Inventors: Ylva Dalen, Lidingo (SE); Christer Osterman, Tullinge (SE); Christopher Muda, Norrkoping (SE); Harald Staiger, Huskvarna (SE)

Correspondence Address: LADAS & PARRY LLP, 224 SOUTH MICHIGAN AVENUE, SUITE 1600, CHICAGO, IL, 60604, US

(21) Appl. No.: 10/539,091

(22) PCT Filed: Dec. 18, 2003
(86) PCT No.: PCT/SE03/01992

§ 371 Date: Jun. 15, 2005

(30) Foreign Application Priority Data
Dec. 19, 2002 (SE) 0203763-8

(51) Int. Cl. A61G 15/00

(52) U.S. Cl. 128/845

(57) ABSTRACT

The present invention relates to a human body supporting device, especially intended for use with children having serious functional disabilities, e.g. cerebral paresis. The device according to the present invention is characterised by comprising a base unit (1) intended to rest on a horizontal ground, an elongated, generally up-right element (5) extending from the base unit (1), a pelvis support (10) attached to the upright element (5), said support being displaceable along the upright element (5), by said pelvis support (10) comprising means (12, 13) for encircling the waist of the person using the device, and by a chest support (15) provided on the upright element (5), said chest support (15) being displaceable along the upright element (5) and comprising means (17, 18) for encircling the chest of the person using the device.

### TECHNICAL AREA OF THE INVENTION

The present invention relates to a human body supporting device, especially intended for use with children having serious functional disabilities, e.g. cerebral paresis.

### STATE OF THE ART

Known body supporting devices primarily for children with cerebral paresis are known as stand-up shells and consist of form-moulded plastic shells, principally extending from the child's ankles to its head. The shell principally covers the rear side of the child's body, the child being strapped into the stand-up shell with belts or the like. The shell is moulded in plastic resin, using a plaster cast for each individual, which entails strains on the CP patient who has to lie still during the plaster casting procedure. The shell cannot be used when the child has grown out of it. This means that new plastic shells have to be manufactured as the child grows. As the child has its body close to the plastic shell, the skin will not be able to breathe to a sufficient degree. One attempt to solve this problem has resulted in the shell being equipped with small aeration holes, which have not, however, resulted in a sufficient cooling of the skin.

A further disadvantage of the known stand-up shells is that the rigid design does not allow movement of the lower extremities, i.e. the legs.

### OBJECTS AND CHARACTERISTICS OF THE INVENTION

A primary object of the present invention is to provide a body supporting device of the type initially described, the device being exceptionally flexible regarding adaptation to the size of the person using the body supporting device.

Another object of the present invention is to momentarily adapt the support to the person utilising the body supporting device.

A further object of the present invention is to provide a body supporting device that can be used both when the person is standing and when he/she is sitting down.

Yet another object of the present invention is that it shall allow independent, lust-filled motion, for example in the form of jumping, and shall allow secure, independent movement.

At least the primary object of the present invention is realised by a device provided with the characteristics defined by the subsequent independent claim 1. Preferred embodiments of the invention are defined by the dependent claims.

### BRIEF DESCRIPTION OF THE DRAWINGS

An embodiment of the invention will be described below, with reference to the appended drawings, wherein:

FIG. 1 shows a perspective view of one embodiment of the device according to the present invention;

FIG. 2 shows a front view of the device according to FIG. 1;

FIG. 3 shows a side view of the device according to FIG. 1;

FIG. 4 shows a fundamental drawing of a shell, included in the device, which is provided with a net;

FIG. 5 shows the shell according to FIG. 4, with the net partially loaded;

FIG. 6 shows the shell according to FIG. 4, with the net fully loaded;

FIG. 7 shows a front view of the device according to the present invention, with a person using the device; and

FIG. 8 shows a side view of the device according to FIG. 7.

### DETAILED DESCRIPTION OF A PREFERRED EMBODIMENT OF THE DEVICE ACCORDING TO THE PRESENT INVENTION

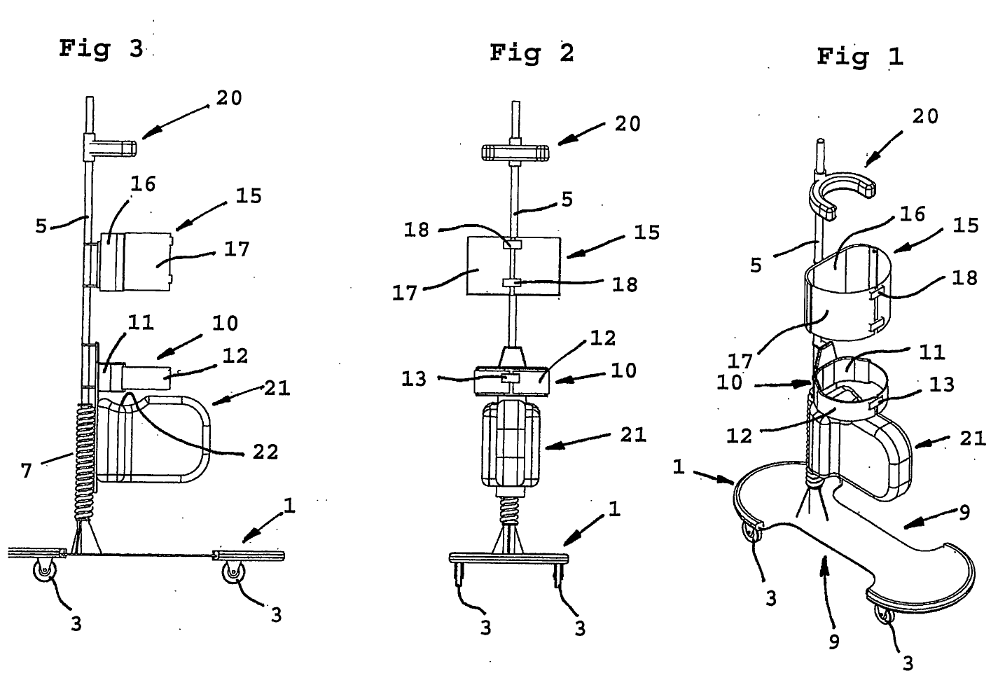

The device according to the present invention illustrated in FIGS. 1-3, comprises a base unit 1, four wheels carrying the base unit 1 on a ground, and an upright element 5, which in the illustrated embodiment consists of a column 5, anchored in the base unit 1 and extending generally perpendicularly to the main plane of the base unit 1. The wheels are preferably comprised of swivelling wheels 3, which results in the base plate 1 being easily movable in various directions on the ground. It is suitable for the swivelling wheels to be lockable, in order to make the device stationary in relation to the ground.

The column comprises a resilient member 7, which in the illustrated embodiment consists of a gas spring. The column 5 is flexibly attached to the base unit 1, enabling the extent of the column 5 relative to the base unit 1 to be varied, i.e. the extension may deviate from the perpendicular one that defines, however, the normal position of the column.

As can be seen in FIG. 1, the base unit 1 exhibits a generally elongated shape, with recesses 9 arranged in the long sides of the base unit. The recesses 9 are provided in order to allow the person using the device according to the present invention to easily reach the floor/ground. This will be described in further detail below.

The device according to the present invention further comprises a pelvis support 10 affixed to the column 5, said support being displaceable along the column 5 for individual adaptation to the person using the device according to the present invention. The pelvis support 10 comprises a first support element 11, made of a flexible but torsionally rigid material, for example a suitable plastic resin. The first support element 11 has the general shape of a curved band, the curve being roughly adapted to that part of the user which is to be received in the first support element 11. The pelvis support 10 further comprises a strap 12, consisting of two portions fastened to the first support element 11, whereby said parts, by means of a first buckle 13, can be strapped around the person using the device according to the present invention.

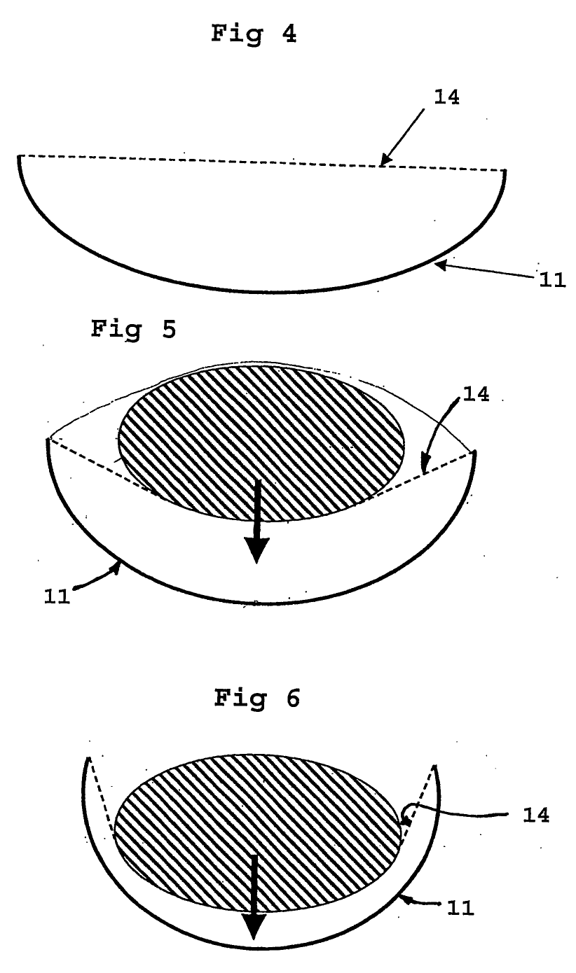

In the first support element 11, a net 14 is provided in the manner shown in FIG. 4. In FIGS. 1-3, the net 14 is not shown. The net 14 is hereby affixed to the short sides of the band-shaped, curved first support element 11 whereby, in the non-loaded condition, the net 14 assumes the position shown in FIG. 4. The fastening of the net 14 to the short sides of the first support element 11 may be made in a multitude of ways whereby, by way of example and not limitation, one arrangement could be mentioned where an edge strip is pressed onto each of said short sides. Thereby, the net 14 will be fixed between the edge strip and the short side of the first support element 11. The net 14 should be relatively non-compliant, in all directions, and should have a low humidity absorbance.

FIG. 5 shows the first support element 11 with its net 14 in a partially loaded position, both the net 14 and the first support element having been deformed to a certain extent, i.e. the net has obtained a certain curvature and the curvature of the first support element 11 has been changed in comparison with that in FIG. 4.

FIG. 6 shows the support element 11 with its net 14 in a fully loaded position, whereby the net 14 has been displaced still closer to the first support element 11, which in turn has obtained a smaller radius of curvature compared with the position according to FIG. 5. There is still, however, a clearance between the net 14 and the first support element 11, said clearance allowing the body heat to be ventilated away.

The device according to the present invention also comprises a support 15 for the chest, attached to the column 5, arranged above the pelvis support 10 and displaceable along the column 5 for individual adaptation to the person using the device according to the present invention. Said chest support 15 comprises a second support element 16, having a generally curved shape, the curve being roughly adapted to that part of the user which is to be received in the second support element 16. The chest support 15 further comprises a girdle 17, consisting of two flexible portions attached to the second support element 16, whereby these portions can be strapped, by means of second buckles 18, around the person using the device according to the present invention.

The second support element 16 may also be equipped with a net, in generally the corresponding manner as the first support element 11. This net is not shown in FIGS. 1-3. The co-operation between the second support element 16 and a net is in principle corresponding to that described above in connection with FIGS. 4-6.

The device according to the present invention also includes a headrest 20, generally having the shape of a semi-circular ring and being displaceable along the column 5. This allows the headrest 20 to be adjusted so as to extend around the back of the head of the person using the device. The headrest is preferably provided with some form of padding and will support the neck.

In the embodiment shown in FIGS. 1-3, the device according to the present invention also comprises a leg divider/seat 21, attached to the column and having the to general shape of a bracket extending from the column 5. The leg divider/seat 21 can be displaced along the column 5 for individual adaptation to the person using the device according to the present invention. In the illustrated embodiment, the leg divider/seat 21 has the general shape of a plate and has, at least in the area of its free end, a thickness smaller than the height of the leg divider/seat 21. A seat 22 is is formed on the topside of the leg divider/seat 21, said seat intended for supporting the seat of the person using the device according to the present invention. As can be gained from FIG. 3, the seat 22 is somewhat lowered in relation to the rest of the topside of the leg divider 21.

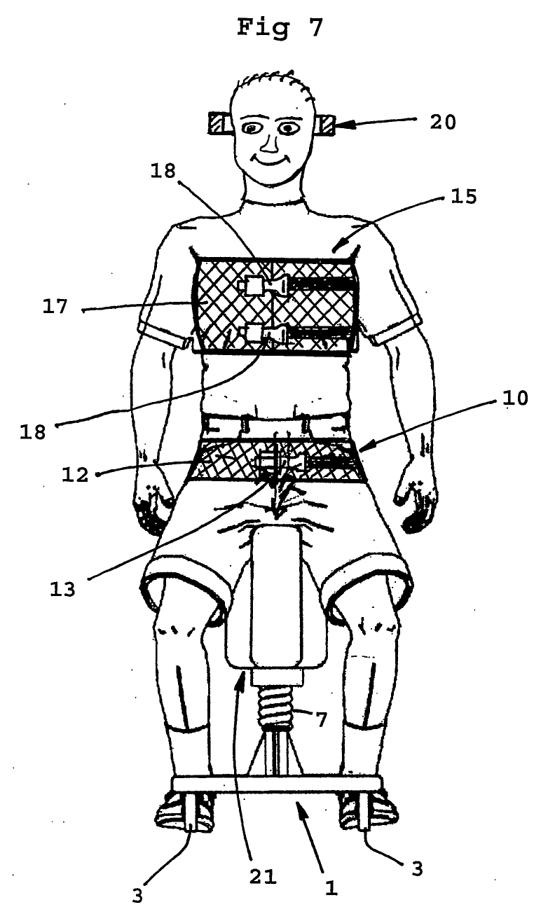

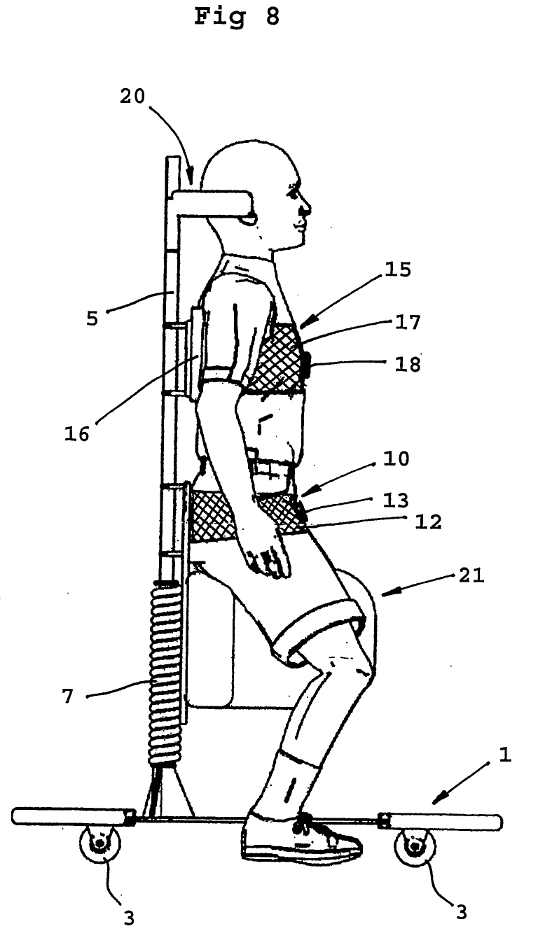

FIGS. 7 and 8 illustrate how a person utilises the device according to the present invention shown in FIGS. 1-3. Hereby the person has placed himself in such a way that his seat is supported by the seat 22, his legs are placed on either sides of the leg divider 21 and his feet are located in the recesses 9. With the position shown in FIGS. 7 and 8, the feet are contacting the ground. The pelvis support 10 is activated, i.e. the lower back of the person contacts the net 14 of the pelvis support 10 and the strap 12 is tightened around the person's pelvis by means of the first buckle 13. In the active condition of the pelvis support 10, a co-operation between the first support element 11 and the net 14 takes place in the manner described above.

As can be seen in FIGS. 7 and 8, the chest support 15 is also active, whereby the upper portion of the person's back contacts the second support element 16, which might be provided with an internal net. The girdle 17 is tightened around the person's chest by means of the second buckles 18. If the support element 16 is provided with a net, the same kind of co-operation takes place as at the pelvis support 10.

As can be seen in FIGS. 7 and 8, the headrest 20 cradles the rear of the person's head and provides it with the necessary support. In this connection one should note that persons suffering from serious functional disturbances often need help to support their head.

By adjustment of the height of the leg divider/seat 21 so that the person can reach down to the ground with his feet, the person is allowed to stand up and perform jumping motions. The existence of the spring 7 allows the person to perform vertical rocking motions, both when the person is standing up and is sitting down on the leg divider/seat 21. In general, one can state that the device according to the present invention principally functions like a chair when the person is sitting down on the leg divider/seat 21, meaning that the person can participate seated at a table or similar. In this situation it is preferable to lock the swivelling wheels 3, making the device stationary on the ground. When the swivelling wheels 3 are released, persons with a limited disability are enabled to displace themselves relative to the ground through putting their feet against the ground.

A study of FIGS. 7 and 8 reveals that, through height adjustment of the pelvis support 10, the chest support 15 and of the headrest 20, adaptation to a growing person can be performed. One will realise that the pelvis support 10, the chest support 15 and the headrest, which may be displaced along the column 5, can be affixed at any chosen height on the column 5 by means of a suitable locking device, for example a toggle fastener. The existence of nets in the pelvis support 10 and in the support 15, allows for these parts to adapt themselves, to a certain extent, to changes in those portions of the person that they are to support. It stands to reason that it will be necessary for the component parts of the device according to the present invention to be available in a number of sizes in order to allow optimal individual adaptation.

Possible Modifications of the Invention

The device according to the present invention described above comprises a leg divider/seat 21. However, within the scope of the invention, it is conceivable to exclude the leg divider/seat 21, thus utilizing the device only as a stand-up support.

In the embodiment described above the base plate 1 is provided with recesses 9, to allow the person using the device according to the present invention to reach the ground with his feet. However, it is conceivable within the scope of the invention, that the recesses 9 are excluded and that the base plate 1 is provided with attachments for the feet of the person using the device according to the present invention. Hereby, the person using it can more easily put his feet against the base plate 1, for example if the person wishes to jump. When using the device in such a manner the swivelling wheels should preferably be locked, entailing that the device could only be moved by means of external help.

1. Human body supporting device, comprising a base unit intended to rest on a horizontal ground, an elongated, generally upright element extending from the base unit, a pelvis support attached to the upright element, said support comprising means for encircling the pelvis of the person using the device, characterised in that a seat is provided on the upright element, and wherein the upright element comprises a resilient means.

2. Device according to claim 1, further comprising a chest support is provided on the upright element, said chest support being displaceable along the upright element and comprising means for encircling the chest of the person using the device.

3. Device according to claim 1 further comprising a leg divider is provided on the upright element and wherein the seat is integral with the leg divider.

4. Device according to claim 1, further comprising a headrest is provided on the upright element, said headrest being displaceable along the upright element.

5. Device according to claim 1, wherein the base unit is supported by wheels.

6. Device according to claim 1, wherein the pelvis support comprises a first support element having a generally curved shape, a strap connected to the first support element, and a net attached to the short sides of the first support element.

7. Device according to claim 6, wherein the first support element is manufactured from a torsionally rigid, flexible material, preferably a plastic resin.

8. Device according to claim 6, wherein the net has a low resiliency in all directions.

9. Device according to claim 6, wherein the chest support comprises a second support element having a generally curved shape, a girdle connected to the second support element, and a net attached to the short sides of the second support element.
